(19) United States
(12) Patent Application Publication
(10) Pub. No.: US 2006/0129532 A1
(43) Pub. Date: Jun. 15, 2006

(54) Form generation system and method

(75) Inventor: Chien-Yuan Chiu, Hsinchu Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/010,761

(22) Filed: Dec. 13, 2004

(51) Int. Cl. G06F 17/30

(52) U.S. Cl. 707/3

(57) ABSTRACT

A system and method for form generation. The system includes at least a processing unit, and a mail system. The processing unit receives an identity, and records a voice file via a network, and generates a request form by integrating the identity and the voice file. The processing unit retrieves client information and a request type according to the identity. The mail system transmits the request form to a system administrator and a client according to the request type and the client information. The processing unit automatically retrieves an answer according to the request form. The mail system transmits the answer to the system administrator for approval, and transmits the answer to the client if the answer is approved by the system administrator.

### BACKGROUND

The present invention relates to a system and method for form generation, and particularly to a system and method that generates request forms with voice attachments.

Customer relation management is critical for high quality service and customer loyalty. Conventionally, clients must call a help desk to report problems or to record request forms. Alternately, these request forms are generated through an interface. The data is then forwarded to the corresponding system administrator. The system administrator then responds to clients.

In the first instance, because the system administrator is not contacted directly, the request form recorded by the help desk may be unclear, which may result in incorrect responses. In the second instance, since the request form may be complicated, additional knowledge may be required to file the report, resulting in complications and inconvenience. Additionally, since there is no online mechanism to complete and directly forward request forms to corresponding system administrators, excessive waiting time may occur.

### SUMMARY

The present invention is proposed to address and solve the aforementioned issues.

Accordingly, it is an object of the present invention to provide a system and method that generates request forms with voice attachments.

It is another object of the present invention to provide a system and method that automatically forwards the request forms to different systems.

To achieve the above objects, the present invention provides a system for form generation. The system includes at least a processing unit to receive an identity and record a voice file via a network, and generate a request form by integrating the identity and the voice file.

The system further includes a transformation unit to transform the voice file into text and to fill in the request form. The system further includes a mail system to transmit the request form to a corresponding system administrator via a wired network, a wireless network, or a telecommunication network according to a request type retrieved based on the identity.

The processing unit further retrieves an answer according to the request form. The mail system transmits the answer to the system administrator for approval, and then transmits the answer to the client if the answer is approved by the system administrator.

According to another embodiment, a method for form generation is provided. First, an identity is received and a voice file is recorded via a network. Then, a request form is generated by integrating the identity and the voice file.

The voice file is further transformed into text which is filled into the request form. The request form is transmitted to a corresponding system administrator via a wired network, a wireless network, or a telecommunication network according to a request type retrieved based on the identity.

An answer is retrieved according to the request form, and transmitted to the system administrator for approval. If the answer is approved, it is transmitted to the client according to client information.

The above-mentioned method may take the form of program code embodied in tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the architecture of the system for form generation according to the present invention;

FIG. 2 is a flowchart showing the process of the method for form generation according to the present invention; and

FIG. 3 is a schematic diagram illustrating a storage medium storing a computer program for execution of the method for form generation according to the present invention.

### DESCRIPTION

The present invention provides a system and method overcoming conventional request form filling problems.

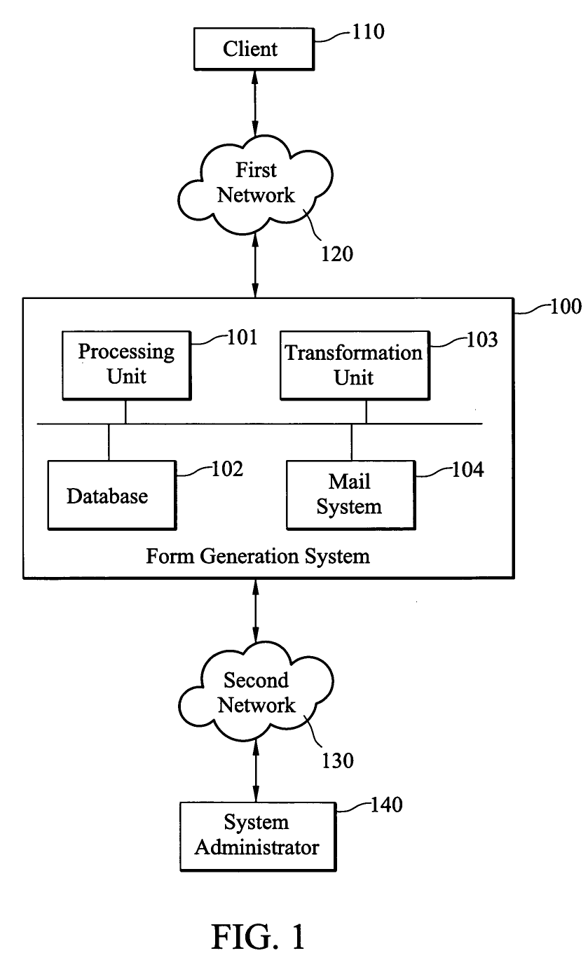

FIG. 1 illustrates the architecture of the system for form generation according to the embodiment of the present invention.

The form generation system 100 includes a processing unit 101, a database 102, a transformation unit 103 and a mail system 104. The processing unit 101 receives signals from the client 110 via the first network 120. The first network 120 may be a wired network, a wireless network, and a telecommunication network. The client 110 may use electronic devices, such as telephones and computers to fill in request forms and attach voice files thereto. Once a communication is established between the client 110 and the system 100, the processing unit 101 receives an identity from the client 110. The identity, such as phone number or an Internet Protocol (IP) address may be automatically recognized by analyzing the signals, or input by the client 110.

The database 102 records client information, request types, and information regarding system administrators capable of responding to respective request types. It is noted that each client is classified into one of the request types.

The processing unit 101 retrieves the client information and a request type according to the received identity, retrieves information of a corresponding system administrator according to the request type, and generates a request form including the client information, the request type, and the information of the system administrator.

The transformation unit 103 transforms the voice file into text according to predefined transformation rules, and fills out the request form. The mail system 104 transmits the request form to the system administrator 140 via a second network 130 according to the information of the system administrator. Similarly, the second network 130 may be a wired network, a wireless network, and a telecommunication network. The mail system 104 further transmits a copy of the request form to the client 110 according to the client information.

The system 100 further includes a database (not shown) storing answers and solutions corresponding to problems for each system. The processing unit 101 further retrieves an answer according to the request form. The mail system 104 further transmits the answer to the system administrator 140 for approval, and transmits the answer to the client 110 if the answer is approved by the system administrator 140.

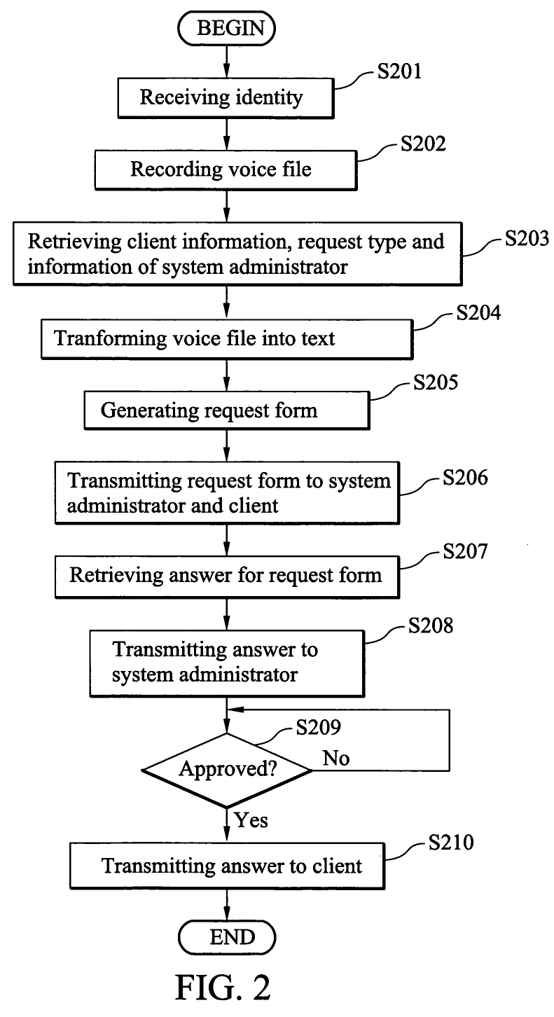

FIG. 2 shows the process of form generation according to the embodiment of the present invention.

In step S201, the processing unit 101 first receives an identity from the client 110 via the first network 120. Similarly, the identity may be automatically recognized by analyzing the signals, or input by the client 110. In step S202, a voice file is recorded. It is noted that the processing unit 101 issues a prompt to the client 110 after the identity is received. Thereafter the client 110 provides voice input through the electronic device and the processing record captures the voice file simultaneously.

In step S203, the processing unit 101 retrieves client information and a request type according to the received identity, and retrieves information of a corresponding system administrator according to the request type. In step S204, the transformation unit 103 transforms the voice file into text. Then, in step S205, the processing unit 101 provides the client information, the request type, the information of the system administrator and text corresponding to the voice file to fill out a request form. In step S206, the mail system 104 transmits the request form to the system administrator and the client, to confirm that the request form is being processed.

Thereafter, in step S207, the processing unit 101 retrieves an answer for the request form from the knowledge database. In step S208, the mail system 104 transmits the answer to the system administrator 140 for approval. If the answer has been approved (Yes in step S209), in step S210, the mail system 104 transmits the answer to the client 110. It is understood that the mail system 104 will wait for response until a result of approval is received. In another case, the procedure is complete if the answer is rejected. It is also understood that if the answer is rejected by the system administrator 140, the system administrator 140 must provide another answer for the request form, and transmit it to the client 110 via the mail system 104.

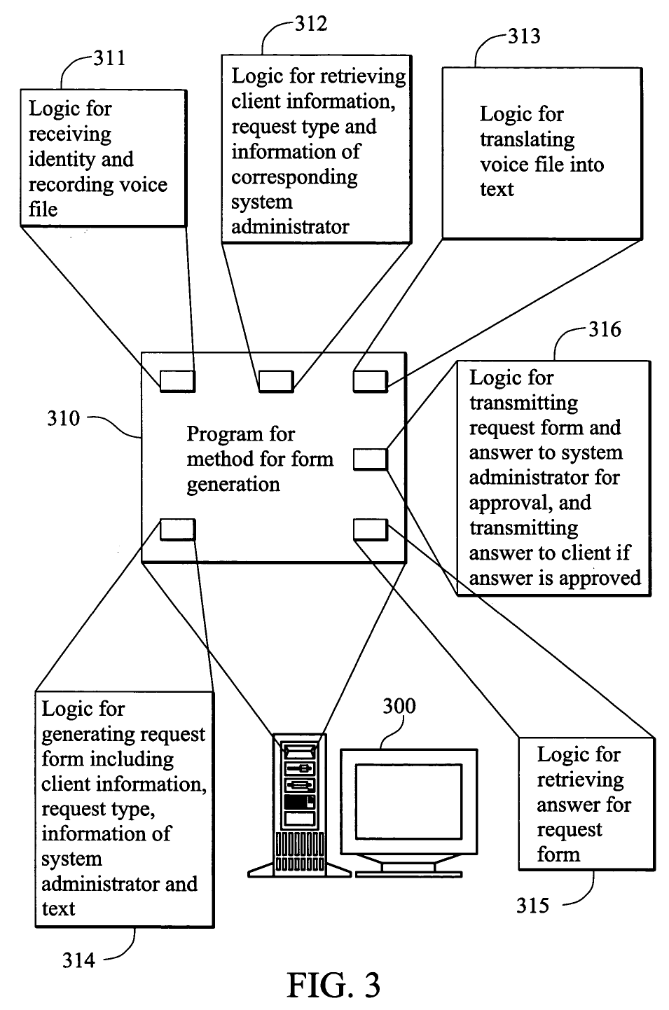

FIG. 3 is a diagram of a storage medium storing a computer program providing the method for form generation according to the present invention. The computer program product comprises a storage medium 310 having computer readable program code embodied in the medium for use in a computer system 300, the computer readable program code comprising at least computer readable program code 311 receiving an identity and recording a voice file, computer readable program code 312 retrieving client information, a request type and information of a corresponding system administrator, computer readable program code 313 transforming the voice file into text, computer readable program code 314 generating a request form including the client information, the request type, the information of system administrator and text, computer readable program code 315 retrieving an answer for the request form, and computer readable program code 316 transmitting the request form and the answer to the system administrator for approval, and transmitting the answer to the client if the answer is approved.

The present invention thus provides a computerized system and method for form generation that automatically generates request forms with voice attachments, retrieves answers for the request forms, and forwards the request forms and the answers to corresponding system administrators, thereby reducing the response time for requests, and improving the accuracy of answers by analyzing the voice attachments.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

What is claimed is:

1. A system for form generation, comprising at least:
a processing unit to receive an identity and record a voice file via a network, and generate a request form by integrating the identity and the voice file.

2. The system of claim 1 further comprising a transformation unit to transform the voice file into text and fill out the request form.

3. The system of claim 1 wherein the processing unit further retrieves a request type according to the identity, and fills out the request form.

4. The system of claim 3 further comprising a mail system to transmit the request form to a corresponding system administrator according to the request type.

5. The system of claim 4 wherein the request form is transmitted via a wired network, a wireless network, or a telecommunication network.

6. The system of claim 4 wherein the processing unit further retrieves client information according to the identity, and fills out the request form.

7. The system of claim 6 wherein the mail system further transmits a copy of the request form to a client according to the client information.

8. The system of claim 6 wherein the processing unit further retrieves an answer according to the request form, and the mail system further transmits the answer to the system administrator.

9. The system of claim 8 wherein the mail system further transmits the answer to the client if the answer is approved by the system administrator.

10. The system of claim 1 wherein the network is a telecommunication network, and the identity is recognized as a phone number.

11. A method for form generation, comprising the steps of:
receiving an identity and recording a voice file via a network; and
generating a request form by integrating the identity and the voice file.

12. The method of claim 11 further comprising translating the voice file into text and filling out the request form.

13. The method of claim 11 further comprising retrieving a request type according to the identity, and filling out the request form.

14. The method of claim 13 further comprising transmitting the request form to a corresponding system administrator according to the request type.

15. The method of claim 14 wherein the request form is transmitted via a wired network, a wireless network, or a telecommunication network.

16. The method of claim 14 further comprising retrieving client information according to the identity, and filling out the request form.

17. The method of claim 16 further comprising transmitting a copy of the request form to a client according to the client information.

18. The method of claim 16 further comprising retrieving an answer according to the request form, and transmitting the answer to the system administrator.

19. The method of claim 18 further comprising transmitting the answer to the client if the answer is approved by the system administrator.

20. The method of claim 11 wherein the network is a telecommunication network, and the identity is recognized as a phone number.

21. A machine-readable storage medium storing a computer program which when executed causes a computer to perform a method for form generation, the method comprising the steps of:
receiving an identity and recording a voice file via a network; and
generating a request form by integrating the identity and the voice file.

22. The storage medium of claim 21 wherein the method further comprises translating the voice file into text and filling out the request form.

23. The storage medium of claim 21 wherein the method further comprises retrieving a request type according to the identity, and filling out the request form.

24. The storage medium of claim 23 wherein the method further comprises transmitting the request form to a corresponding system administrator according to the request type.

25. The storage medium of claim 24 wherein the request form is transmitted via a wired network, a wireless network, or a telecommunication network.

26. The storage medium of claim 24 wherein the method further comprises retrieving client information according to the identity, and filling out the request form.

27. The storage medium of claim 26 wherein the method further comprises transmitting a copy of the request form to a client according to the client information.

28. The storage medium of claim 26 wherein the method further comprises retrieving an answer according to the request form, and transmitting the answer to the system administrator.

29. The storage medium of claim 28 wherein the method further comprises transmitting the answer to the client if the answer is approved by the system administrator.

30. The storage medium of claim 21 wherein the network is a telecommunication network, and the identity is recognized as a phone number.
